(19) United States
(12) Patent Application Publication
(10) Pub. No.: US 2005/0125835 A1
(43) Pub. Date: Jun. 9, 2005

(54) Service/channel installation

(75) Inventor: Yumin Wei, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklijke Philips Electronics N.V.

(21) Appl. No.: 10/506,835

(22) PCT Filed: Feb. 12, 2003
(86) PCT No.: PCT/IB03/00581

(30) Foreign Application Priority Data
Mar. 11, 2002 (EP) 02075944.5

(51) Int. Cl. H04N 7/173

(52) U.S. Cl. 725/100

(57) ABSTRACT

A broadcast receiver 200 includes a receiver/decoder 210. The receiver 200 receives a broadcast channel selected by a user from a plurality of broadcast channels available in a broadcast network The receiver makes signals broadcast via the selected channel available to the user. User input means 230 enable the user to specify a user interest profile 400 based on at least one category of preference 410, 420, 430. An installer 220 install of all channels available in the broadcast network only those channels that meets the user interest profile 400.

### FIELD OF THE INVENTION

The invention relates to a method of installing channels in a broadcast receiver and to a broadcast receiver.

### BACKGROUND OF THE INVENTION

U.S. Pat. No. 6,252,635 discloses a method of installing channels in a broadcast receiver for an analogue broadcast system. The network provider transmits a list of tuning frequencies or channel numbers of all receivable broadcast stations. The list is referred to as the channel list. Usually the channel list is transmitted along with at least one of the broadcast television programs, e.g. as a cyclically transmitted teletext page. Upon installing the broadcast receiver, the channel list is captured by tuning into one of the channels. The channel list is then decoded and stored in a memory (effecting installation of all the channels on the list) without requiring any further user intervention. Thereafter, all channels are accessible through the program numbers defined by the network provider. It is also possible to automatically install only those channels that are part of the subscription package to whom the user has subscribed.

Increasingly digital audio/video transmission systems are used. Taking the DVB (Digital Video Broadcasting) system as an example, a network provider broadcasts a number of transport streams, each containing a number of services. Usually, the transport streams are transmitted in distinct frequency bands (frequency multiplexing), whereas the services are coded into the stream using time multiplexing. A service is usually referred to as a channel. A receiver includes a tuner for tuning to a specific transport stream and a decoder for extracting a specific service/channel from the stream. In DVB, the transport streams are MPEG-2 transport streams. The network is defined as the collection of MPEG-2 transport stream multiplexes transmitted via a single delivery system. For certain delivery systems, such as a satellite delivery system, there can be more than one network. Consequently, a channel is identified by a network_id identifying the network, a transport_id identifying the stream within the network, and a service_id identifying the service/channel within the stream. From a tuning perspective, an analogue channel is comparable to a digital transport stream. From a user perspective, a channel corresponds to a certain frequency band for an analogue system and to a service/channel in a transport stream for a digital system.

Nowadays the number of available channels can be very high. Even using an analogue delivery system, a network provider may supply several hundreds of channels. Using a digital delivery system, the number of channels available through the combination of all transport streams can even be higher. This makes it necessary to manage or enable a user to manage a very large number of channels.

### SUMMARY OF THE INVENTION

It is an object of the invention to improve the method of installing channels in a broadcast receiver and to improve the broadcast receiver.

To meet the object of the invention, the method of installing channels in a broadcast receiver includes the steps of determining a user interest profile based on at least one category of preference; and installing of all available channels only a subset that meets the user interest profile. The known method of installing channels results in installing all channels indiscriminately, having no regard to preferences of a user. Consequently many channels may be installed in which the user is not interested at all. The method according to the invention overcomes this drawback by installing only those channels that meet preferences of the user. It should be noted that in itself various schemes are known for creating a profile used to select among all programs available on all channels only those that meet an interest of the user. Much attention has been given to adaptive, automatic learning schemes to reduce the burden in removing undesired programs from viewing lists in the EPG. However, such schemes first install all channels indiscriminately and only afterwards assist the user in managing the overload of channels and remove or hide undesired channels.

As defined in the dependent claim 2, selection criteria may include language of a channel; country/area of a service provider associated with a channel; and type of a channel. Taking the language as an example, the method according to the invention enables avoiding that channels are installed on which (only or primarily) programs are transmitted in a language in which the user is not interested. In the conventional systems, the user may need to mark all of those channels as being undesired to ensure that no information on programs broadcast via those channels is displayed in an Electronic Program Guide (EPG) or that those channels will be skipped in the channel selection. In an adaptive learning system it may take a considerable period before the system no longer provides information on channels/programs in languages in which a user is not interested. By using user-specific installation profiles, usage of the receiver can be simplified. Moreover, memory can be saved for storing channels. The memory saving can extend to all applications running on the receiver whose memory requirements depends on the number of installed channels. For instance, by reducing the number of installed channels from 200 to only 20 using a user-specific installation profile may also reduce the initial size of the EPG by a factor 10.

As defined in the dependent claim 3, the method includes retrieving for each of the channels property values for each preference category in the user profile. In principle, information may be retrieved for all preference categories. However, to speed-up the retrieval process, it is preferred to only retrieve information for the categories selected by the user as part of the profile.

As defined in the dependent claim 4, for each channel, (digital) information is broadcast on its values for each of the categories (e.g. language=English; channel type=news). In an analogue system, the information may be retrieved by tuning into each of the channels and extracting the values. In the digital DVB system, the information may be retrieved by tuning into each of the transport streams and extracting the channel information from the steam by (partial) decoding of the stream. To speed up the information gathering, as defined in the dependent claim 5, an analogue channel may carry information for other channels as well. Similarly, a digital transport stream may also include information on channels not part of the stream. Preferably, an analogue channel (or digital transport stream) includes information for all channels of the same service provider, or even for all channels supplied by the network provider. To assist the receiver in locating such channel(s)/streams with information for more than one channel, the user may need to specify such a channel/stream to the receiver. Preferably, the receiver is pre-programmed with the frequency of such a channel/stream. The channel/stream may also simply be the first available channel/stream.

As defined in the dependent claim 6, the broadcast receiver includes at least two receiver/decoders. This makes it possible that at least part of the installation, e.g. the collecting of the channel-specific information, occurs in the background while the user can already use the system. The receiver/decoder used for the installation can, after the installation has been completed, be used for other purposes, such as acting as a second source to enable independent viewing and recording.

As defined in the dependent claim 7, several user profiles can be defined optimizing the method for families with family members with diverging interests.

As defined in the dependent claim 8, the user may update its installation profile. Preferably, the set of installed channels is adapted in the background (e.g. using the second receiver/decoder), making the method very user-friendly.

As defined in the dependent claim 9, the user interest profile is not only used during installation but also forms the basis of profile-based usage of the system. As such, the installation profile acts as the bootstrap for the well-known program profiles used after installation, as for example used by EPGs. Particularly if such usage profiles are self adapting, these profiles can benefit significantly from an automatically provided starting profile.

As defined in the dependent claim 10, the properties of the installation profile (targeted at making a selection between channels) are re-used in a profile for selecting or ranking programs when actually using the receiver after installation. For instance, properties like channel type, and language can very effectively be used in to improve presentation of an EPG.

To meet the object of the invention, the broadcast receiver includes a receiver/decoder for selectively receiving a broadcast channel from a plurality of broadcast channels available in a broadcast network and receiving signals broadcast via the selected channel; means for receiving a user interest profile based on at least one category of preference; and an installer operative to install of all channels available in the broadcast network only a subset that meets the user interest profile.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a broadcast system in which the broadcast receiver can be used;

FIG. 2 shows a block diagram of the broadcast receiver;

FIG. 3 shows a further embodiment of the broadcast receiver, and

FIG. 4 shows the storing of two profiles.

### DETAILED DESCRIPTION

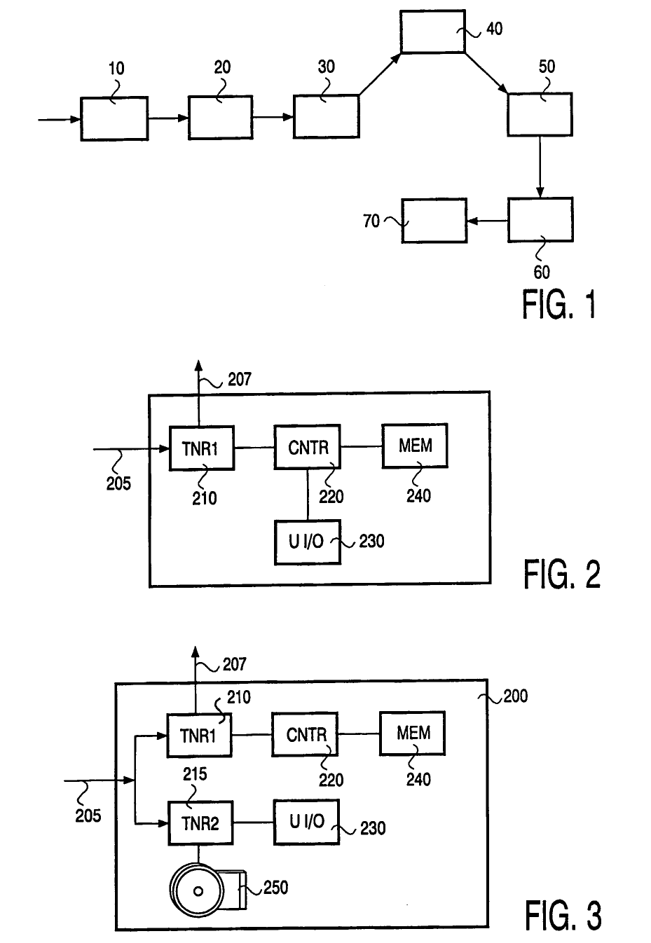

FIG. 1 gives an overview of a digital television system in which the receiver according to the invention can be used. As an example, a system is described wherein the audio/video (A/V) signals are distributed digitally. In principle, the invention can also be used in analog systems. The system will be described for using MPEG-2 compression to compress the A/V signals. The system includes an MPEG-2 compressor 10, usually located in a broadcast centre. The compressor receives a digital signal stream (typically a stream of analog or digital video signals). The original signals are supplied by a service provider. The compressor is connected to a multiplexer and scrambler 20. The multiplexer 20 receives a plurality of further digital signals, assembles the transport stream and supplies compressed signals to a transmitter 30 of the broadcast centre. The signal may be supplied using any suitable form of linkage, including telecommunication links. The transmitter 30 transmits electromagnetic signals via an uplink towards a satellite transponder 40, where they are electronically processed and broadcast via a downlink to an earth-based satellite receiver 50, conventionally in the form of a dish of the end user. The satellite receiver 50 is connected to an integrated receiver/decoder 60. The receiver 60 can be tuned to the various frequency multiplexed transport streams (demultiplexing). The decoder part decodes transport stream into separate the channels/services and can decode the compressed MPEG-2 signal in such a channel into a signal for use by a rendering device, such as a television 70. Of course, the signal may also be recorded using a tape, optical disc or hard disk recorder or other suitable recorder. The signal may be supplied to the rendering/recording device in an analog or digital form using well-known distribution systems such as CATV cable, or IEEE 1394. For digital distribution only partial decoding of the transport stream is required, where the de-multiplexed signals are supplied in the MPEG-2 coding using partial transport streams. The receiver/decoder may be separated into a tuner and a decoder.

It will be understood that the main distribution does not need to take place via satellite. Instead other delivery systems (i.e. the physical medium by which one or more multiplexes are transmitted) may be used, such as terrestrial broadcast, cable transmission, combined satellite/cable. The party that distributes the program via the delivery system is sometimes referred as the network provider. It will also be understood that the receiver/decoder 60 may be integrated into the rendering or recording device.

The system is designed to operate as a multi-channel system. Typically this also implies that the multiplexer 20 can handle A/V information received from a number of (parallel) sources and interacts with the transmitter 30 to broadcast the information along a corresponding number of channels or multiplexed into separate transport streams. In addition to A/V signals, messages or applications or any other sort of digital data may be introduced in some or all of these channels interlaced with the transmitted digital audio and video information. As such, with the installation of channels is meant A/V related broadcast services covering the installation of A/V broadcasted channels and their associated digital services.

Not shown is a conditional access system that may be used to enable conditional access (e.g. after having taking a subscription) to channels/broadcasts from one or more broadcast providers (or service provider). For the invention it is not relevant whether a conditional access system is used.

FIG. 2 provides more details of a broadcast receiver 200 according to the invention. The broadcast receiver 200 includes a receiver/decoder 210, as described in FIG. 1 under number 60. Usually, the receiver 200 is operated under control of a controller 220, which typically includes a microprocessor. A user interface 230 enables the receiver to interact with the user. The user interface 230 may include any suitable user input means, such as an Infrared receiver for receiving signals from an IR remote control, a keyboard, or a microphone for voice control. For output, also any suitable form may be used, such as using a small LCD display or using the display of a television, or even audible feedback. During normal operation, the user selects a channel. Usually this is done by the user indicating a preset number using the user interface 230. Using a table with all installed channels stored in a memory 240, the preset number is translated into a form suitable for controlling the receiver/decoder 210. For an analogue systems, this information may be in the form of a nominal frequency or channel/band indication. For a digital system this may be an identification of the channel including the network_id, transport_stream_id and channel_id. Using a network information table (NIT) transmitted in the digital stream, the transport_stream_id can be translated to frequency, enabling the receiver to tune to the transport stream. Based on this information, the receiver/decoder selects one broadcast channel from the plurality of channels being broadcast. The multiplexed channels, which are usually frequency multiplexed (or time-multiplexed in a transport stream), are received via an input 205. The receiver/decoder extracts the A/V information broadcast via the selected channel and makes the A/V signal and additional information (if applicable) available via an output 207. Instead of via presets, the user may also use an EPG displayed on a television display to select a program and, inherently coupled thereto, a channel.

According to the invention, the receiver 200 enables the user to specify a user interest profile using the user interface 230. Alternatively, the user interest profile may be received in any other suitable form. As an example, the user may have indicated its interests to the service provider, e.g. by ticking category boxes on a paper form, by specifying the profile via Internet, or by phoning the customer service department. The service provider can then compile a suitable electronic interest profile and transmit it to the broadcast receiver (e.g. in one of the transport streams). Preferably, the profile is based on more than one category of preference. Preferred categories are: language (e.g. main language used by the broadcast/service provider for the channel), country/area of the broadcast/service provider, and channel type (e.g. main type of programs broadcast via the channel). The receiver 200 may come preprogrammed with information on available preference categories and the options within each category. The user may also program the receiver with this information, e.g. via a smartcard, or by downloading the information form the internet into the receiver. Preferably, the receiver automatically collects this information, for instance by automatically downloading it from the internet or retrieving it in the form of additional digital information from one or more of the broadcast channels.

Preferably, the receiver uses the user interface 230 to enable the user to specify the profile in a user friendly way, e.g. using a menu or hypertext-based display enabling the user to quickly specify a profile. As an example, a receiver primarily targeted at the Dutch market could offer the user the following choice:

Country/area

| | |
|---|---|
| The Netherlands | Yes/No |
| UK | Yes/No |
| Germany | Yes/No |
| Belgium | Yes/No |
| US | Yes/No |
| All | Yes/No |

Language

| | |
|---|---|
| Dutch | Yes/No |
| English | Yes/No |
| German | Yes/No |
| French | Yes/No |
| All | Yes/No |

Channel type

| | |
|---|---|
| Sport | Yes/No |
| News | Yes/No |
| Music | Yes/No |
| Movies | Yes/No |
| Children | Yes/No |
| General | Yes/No |
| All | Yes/No |

In addition to specifying categories, preferably the user can also select individual channels. In a digital system, like the DVB system, the transport stream includes the channel name of all channels in the stream. This information (or a subset thereof) can be presented to the user, to enable the user to select a specific channel. As an example, the user can specify ‘CNN’ as a desired station. The user can also ensure that CNN will be installed by specifying country/area=US, language=English, and channel type=news, but this can easily result in the installation of many unwanted stations (e.g. NBC news).

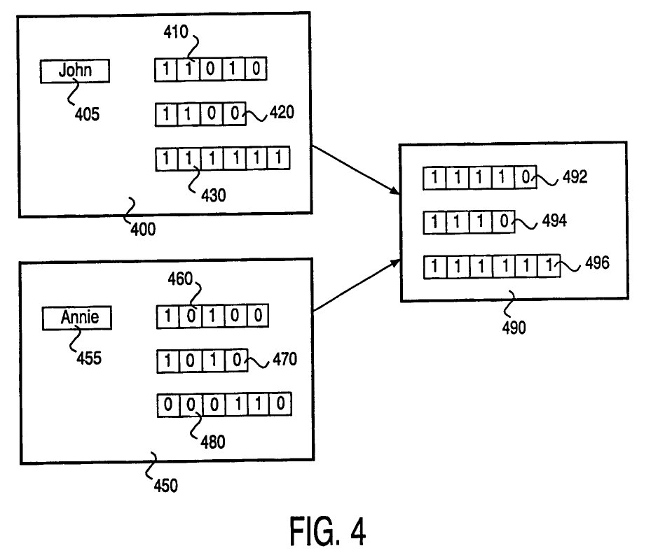

The receiver 200 includes an installer that is operative to install of all available channels only a subset that meets the user interest profile. Normally, this selection process will be performed by the controller 220 under control of a suitable program. To be able to do the selection, the controller compares information on each of the available channels against the profile. The profile itself will normally be stored in a memory of the receiver 200, for instance in the same memory 240 as used for storing tuner settings. For each channel, the stored profile is compared against channel-specific information for each preference category defined in the profile. As an example, assuming that a user would like CNN to be installed as channel 20, the property values of the three exemplary preference categories for channel 20 are: US, English and News. Assuming that the user has made a choice of a property value for each of the three categories, a channel will usually only be selected for installation if all three channel-specific properties match. It should be noted that a property value, such as ‘all’, may in fact mean that that category is not selected, Other choices in the profile may give a match with more than one property value of the channel. As an example, a profile property value ‘sport’ for the preference category program type may match with a value ‘sport’, ‘football’, ‘golf’ etc. Preferably, the receiver enables the user to specify more than one value in each category, as shown in above menu example, where each value can be selected independently. It is well-known in the art how such a selection process can be programmed, e.g. using suitable bit-masks. As an example, FIG. 4 shows for the three categories country/area, language and channel type, three respective bit maps 410, 420 and 430. Referring to the sequence of choices as described above, for the country/area The Netherlands, UK, and Belgium have been selected as illustrated by the binary ‘1” value at these positions and a binary ‘0’ at the other positions. For the language, Dutch and English has been selected. For the channel type, the choice ‘All’ has resulted in all bits being set.

The channel-specific property values may be supplied to the receiver by the user, e.g. on a smart-card or after downloading it from the internet. Preferably, the broadcast receiver 200 automatically retrieves, for all available channels, channel-specific information on the preference category property for the channel. This may be done by downloading the information from the internet. Since a bi-directional link to obtain such information may not be available, it is preferred that the broadcast receiver obtains the information from digital information broadcast via one or more of the channels in the system, or in a digital DVB system, via one or more streams. Such an operation is typically controlled by the controller. The channel-specific information may be retrieved by, starting from the first analogue channel or digital transport stream, sequentially causing the receiver/decoder to tune to the analogue channel (or transport stream for a digital DVB system) and extracting the information from a stream of digital data broadcast via the channel/transport stream, and afterwards increment the channel/transport stream. Suitable property values are already present in tables of the MPEG2 transport stream as defined for DVB.

Instead of scanning all analogue channel streams individually, it is preferred that a channel not only includes its own property values, but also provides information on other channels. For instance, a channel of one broadcast/service provider may include information on all channels of the same provider. E.g. the BBC1 channel may also include information on the BBC2, BBC Gold and BBC World channel, and vice versa. Having obtained information from one of those channels, the receiver needs no longer to scan the other channels on which it already obtained information. This speeds up the installation. The process can be made very fast if information on all channels is regularly transmitted via all channels. It is of course sufficient if the information is transmitted on at least one of the channels, preferably on a channel known to the receiver as providing that information. The first channel (i.e. lowest possible) can advantageously be used for that. For a digital system, like DVB, in an analogous way, a transport stream preferably does not only convey information on the channels in that stream but also on channels in at least one other stream.

FIG. 3 discloses a further embodiment of the broadcast receiver 200. The receiver includes at least one more receiver/decoder. Shown is the additional receiver/decoder 215. One of the receiver/decoders, e.g. receiver/decoder 215, is used for installation, for instance to obtain the channel-specific property values by scanning some or all of the channels/transport streams. Having collected this information, the receiver 200 also has information on the available preferences categories and possible selection a user can make in each category. This information can be used to allow user friendly definition of the profile, e.g. using menus as described earlier. The other receiver/decoder, e.g. receiver/decoder 210, can during the installation process already be used for viewing some channels. After installation the second receiver/decoder can in the background be used for regularly checking if new channels have become available matching the profile. If so, such a channel can be added, if required after having obtaining confirmation from the user. Similarly, channels that have been redefined by the service provider and no longer match the profile can be removed. Preferably, the controller 220 enables the user to redefine its user interest profile via the user interface 230 after installation has been completed. As described above this may result in de-installing installed channels that no longer meet the updated user interest profile, and installing all available channels that meet the updated user interest profile and have not yet been installed. If the receiver only has one receiver/decoder, the re-installation may make the receiver unavailable for normal operation while the installation takes place. Using two receiver/decoders, the reinstallation can take place in the background.

Preferably, the additional receiver/decoder is also used for other purposes than the installation. As an example, the receiver/decoder 215 can be used as a second source, e.g. to allow simultaneous recording on a disk system 250, while the user views the program received via receiver/decoder 210.

In a preferred embodiment, the receiver 200 can install channels according to the wishes of more than one user. To this end, the controller 220 is programmed to obtain via the user interface 230 information for a plurality of users to enable the controller to build for each of the users a respective user interest profile. The profiles are stored in the memory 240. Preferably, an identification of the user, such as a name, is also stored in association with the profile. In FIG. 4, two profiles are stored, profile 400 and 450, with the respective names 405 ‘John’ and 455 ‘Annie’. The profile of Annie corresponds to choices The Netherlands and Germany for the Country/area, Dutch and German for the language, and Movies and Children for the Channel type. The controller 220 ensures that all channels are installed that meet at least one of the respective user interest profiles. Instead of comparing the property values of each channels against all profiles, the receiver can also once build an overall profile (an ‘OR’ combination of all profiles) and use that as the profile for installation. The combined profile is shown as 490 with the three combined bit maps 492, 494 and 496 for Country/area, the language and the Channel type, respectively.

Preferably, at least part of the user profile(s) is kept for use after the installation process. This may involve translating the profile to a form more suited for later usage. Particularly, preference categories such as language and channel type can easily be re-used, where channel type can be converted to a corresponding program type. The same or converted attributes can then be re-used for selecting and/or ranking programs broadcast or to be broadcast via the installed channels. Obviously, the receiver then needs information on the programs transmitted via the installed channels. Any suitable mechanism, such as retrieving EPG data may be used for this purpose.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The words “comprising” or “including” do not exclude the presence of other elements or steps than those listed in a claim. The invention can be implemented by means of hardware comprising several distinct elements, and by means of a computer suitably programmed to implement the method according to the invention. The program may be loaded permanently in the receiver. The program may also be distributed in any suitable form, like on a storage medium such as a CD-ROM, or via a network such as Internet.

1. A method of installing channels in a broadcast receiver, the method including the steps of:
determining a user interest profile based on at least one category of preference; and
installing of all channels available in a broadcast network only a subset that meets the user interest profile.

2. A method as claimed in claim 1, wherein the user interest profile is based on at least one of the following categories of preference:
language of a channel;
country/area of a service provider associated with a channel; and
type of a channel.

3. A method as claimed in claim 1, wherein the method includes automatically retrieving, for all available channels, channel-specific information on the preference category for the channel.

4. A method as claimed in claim 3, wherein the step of retrieving the channel-specific information for all available channels includes for each one of plurality of distinct frequency bands:
causing a receiver/decoder of the broadcast receiver to tune to the frequency band; and
extracting, from a stream of digital data broadcast via the band, the channel-specific information for at least one of the channels transmitted in the band.

5. A method as claimed in claim 3, wherein in the step of retrieving the information includes causing a receiver/decoder of the broadcast receiver to tune to a predetermined frequency band; and extracting, from a stream of digital data broadcast via the predetermined frequency band, the channel-specific information for at least one channel transmitted in a different frequency band.

6. A method as claimed in claim 3, wherein the broadcast receiver includes at least two receiver/decoders, the method including enabling a user to receive broadcast audio/video signals via an already installed channel using a first one of the receiver/decoders while using a second one of the receiver/decoders to receive the channel-specific information.

7. A method as claimed in claim 1, including determining for a plurality of users a respective user interest profile and installing of all available channels only a subset that meets at least one of the respective user interest profiles.

8. A method as claimed in claim 1, including enabling a user to update the user interest profile after installation has been completed, de-installing installed channels that no longer meet the updated user interest profile, and installing all available channels that meet the updated user interest profile and are not yet installed.

9. A method as claimed in claim 1, including storing at least part of the user interest profile and using the stored part of the user interest profile to enable user-specific usage of the broadcast receiver after installation.

10. A method as claimed in claim 7, including using the stored part of the initial user interest profile for selecting and/or ranking programs broadcast or to be broadcast via the installed channels.

11. A broadcast receiver including:
a receiver/decoder for selectively receiving a broadcast channel from a plurality of broadcast channels available in a broadcast network and receiving signals broadcast via the selected channel;
means for obtaining a user interest profile based on at least one category of preference; and
an installer operative to install of all channels available in the broadcast network only a subset that meets the user interest profile.
